(19) United States
(12) Patent Application Publication
(10) Pub. No.: US 2005/0139674 A1
(43) Pub. Date: Jun. 30, 2005

(54) Technique for reading data from a recording medium without contact and processing the read data

(75) Inventors: Masaaki Ishibashi, Yamato-shi (JP); Xiaozhou Wang, Yokahama-shi (JP); Mikito Hirota, Yokahama-shi (JP); Kazuhiro Yabuta, Yamato-shi (JP)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, ARMONK, NY (US)

(21) Appl. No.: 11/021,187

(22) Filed: Dec. 22, 2004

(30) Foreign Application Priority Data
Dec. 24, 2003 (JP) 2003-426956

(51) Int. Cl. G06K 7/10; G06K 7/14; G06K 19/00

(52) U.S. Cl. 235/454; 235/487

(57) ABSTRACT

A technique for retrieving and processing data retrieved from a non-contact recording medium without physically contacting the non-contact recording medium. The non-contact medium contains coded data including a data declaration, a graphical user interface, a determining function, and specification of a communication protocol. A portable terminal reads the data from the non-contact medium, decodes the data into a structured language code file including a data declaration function, a determining function, and a communication protocol specifying function, and stores the code file. A user may select a stored code file, which executes on the portable terminal and performs display control. The portable terminal then communicates data from the selected code file to an external device by using a specified communication protocol from the selected code file.

### BACKGROUND OF THE INVENTION

1. Field of the Invention

The present invention relates to a non-contact readable recording medium, a portable terminal, a portable terminal control method, a computer-executable program for causing a portable terminal to perform the control method, and an information processing system.

2. Description of the Related Art

With advances in computer technology, the performance of portable terminals has improved dramatically in recent years. On the other hand, approaches to accessing computers and other electric appliances, referred to as ubiquitous approaches, have been proposed. As the performance of portable terminals increase, a shift to ubiquitous living environments is becoming a real possibility.

In the above ubiquitous environment, portable terminals will more frequently communicate with electric products such as electric appliances, communication equipment, and information processing devices via non-contact type data media such as QR codes or IC tags. As non-contact media, non-contact reading type recording media (hereinafter referred to as non-contact media) such as QR codes and IC tags have been proposed. However, for data recorded on non-contact media, various data forms and access protocols have been used and are not united. Accordingly, data for non-contact media are individually defined so as to be compatible with individual applications. Thus disadvantageously, such data cannot be commonly used. To solve this problem, it has recently been proposed that an architecture, such as Tron, be used with an operating system so as to operate non-contact media under a single software umbrella.

However, even in this case, since the data form and a method of accessing a recording medium vary with applications, it is difficult to develop common applications, as well as information and services provided by the applications. Furthermore, since various data forms and access methods have been defined, it is difficult develop platforms for developing applications from a united viewpoint.

As described above, data in different formats suitable for different applications have been stored on non-contact media. Accordingly, application providers have had to provide applications compatible with individual formats. Therefore, application providers have a problem in that they are unable to efficiently develop applications and information cannot be shared among applications. These problems have prevented efficient development of integrated applications and restricted the usability of non-contact media.

Furthermore, a need exists for enabling integrated development and provision of applications and services that use data recorded on non-contact media and are less dependent on the hardware of portable terminals in order to improve the usability of the portable terminals and convenience to the users, because a higher commonality can be provided to applications and services.

Moreover, it would further improve the usability of portable terminals and eventually improve the availability of information to users if communication protocols used by a portable terminal can be flexibly changed, because by doing so they could be used for controlling devices on demand. The present invention can control devices included in portable terminals and their device drivers as well as devices capable of communicating with the portable terminals over a wired network, a wireless network, and an infrared network.

### BRIEF SUMMARY OF THE INVENTION

The present invention has been made in view of the prior art described above, and an object of the present invention is to provide a non-contact medium that can improve the usability of non-contact media and portable terminals.

Another object of the present invention is to provide a portable terminal capable of providing a given application to a user by reading data from the above-mentioned non-contact medium and performing a process.

Yet another object of the present invention is to provide a method for controlling the above-mentioned portable terminal to perform processes desired by a user and a computer-executable program for causing a computer to perform the method.

The present invention is provided under the assumption that a non-contact medium and a portable terminal can be significantly efficiently utilized provided that in particular the portable terminal can be provided with a wide range of functions by allowing data containing a data declaration, a user interface function, a user event determining process function, and a communication protocol specifying function to be recorded on the non-contact medium instead of using the non-contact medium simply as a data recording medium.

According to the present invention, recorded on a non-contact medium are a data declaration required in an application, a graphical user interface function for inputting the data into the application, a code for performing a determination process according to a user's choice, and a code for specifying a communication protocol. Stored on a portable terminal, on the other hand, is an application program including a minimum of functionality required for reading data from the non-contact medium, converting the data into a code file, and selectively performing activation or deletion of a code file. The application program is provided to the user as a minimum set of modules, including an application programming interface (API) and a structured language program executing section.

The application program decodes data read from the non-contact medium into a code file in a structured language format such as HTML, XHTML, XML, SGML, and Java® and stores it in a memory device with an identifier. Java is a trademark of Sun Microsystems, Inc. Furthermore, the application program can execute or delete a stored code file in response to a user request. The code file contains required variable declarations, a graphical user interface (GUI) function, a determining function, and a communication protocol specifying function. The application program can present the GUI on the display screen of the portable terminal to the user and cause a process desired by the user to be executed simply by reading the code file and causing it to be executed. The non-contact medium according to the present invention may be a printed or screen-displayed two-dimensional code. The non-contact medium according to the present invention may be a QR code or an IC tag.

According to the present invention, there is provided a device-readable recording medium read by a sensor in a non-contact manner, the recording medium retaining data that provides a device with: a data declaring section that specifies input data and contents of the data; a determining function section that causes a process to be executed in response to a user event; and a communication protocol specifying section.

The recording medium in the present invention may be a two-dimensional code or an IC tag. After being read by a device, the recording medium according to the present invention provides a code file in a structured language and including the data declaring section, the determining function section, and the communication protocol specifying section. The structured language in the present invention is HTML, XHTML, XML, SGML, or Java.

According to the present invention, there is provided a portable terminal connected at least to a network, the portable terminal including a data acquiring section, a processing section, and a display function section, the processing section including: a data decoding section that loads coded data containing a data declaration, a determining function, and a communication protocol specifying function, from a recording medium read by the data acquiring section in a non-contact manner, decodes the coded data, and provides a code file described in a structured language; and an execution environment providing section that provide an environment for executing the code file, wherein the portable terminal establishes communication with an external device in accordance with a communication protocol specified by the code file.

The portable terminal in the present invention further includes an external-communication processing section for communicating with an external device in response to a user event. The data acquiring section in the present invention includes a CCD, a photosensor, or a magnetic sensor.

The data decoding section of the present invention generates a structured language code file from acquired two-dimensional code data or magnetically recorded data. In the present invention, the acquired data is converted into a structured language format in response to a user instruction or, after being read, without a user instruction. The portable terminal according to the present invention generates a graphical user interface in a structured language selected from the group consisting of HTML, XHTML, XML, SGML, and Java, and communicates with an external device. The portable terminal according to the present invention is a mobile phone, a PDA, or PHS and controls an external device through infrared communication. The portable terminal according to the present invention is a mobile phone, a PDA, or a PHS and communicates with a server over a network by packet communication.

According to the present invention, there is provided a portable terminal connected at least to a network and including an input device with a CCD or photosensor or a magnetic sensor, a CPU, and an external communication device, the input device loading coded data containing a data declaration and a determining function from a recording medium read by the data acquiring section in a non-contact manner, the CPU decoding the loaded data, generating a code file described in a structured language, storing the code file in a memory device, reading a selected code file in response to a user event for execution, and communicating with an external device through the external communication device using a protocol specified by the selected code file.

The CPU in the present invention causes the portable terminal to implement: a data decoding section for providing a code file in a structured language; and an execution environment providing section for providing an execution environment for the code file; and allows the portable terminal to establish communication with an external device in accordance with a communication protocol specified in the code file.

The portable terminal includes a display device, wherein a graphical user interface is generated by using the code file and the user interface is displayed on the display device. The data acquiring section includes a CCD or a magnetic sensor. The CPU generates a structured language code file from acquired two-dimensional code data or magnetically recorded data; the acquired data is converted into a structured language to provide a data declaring code, a graphical user interface code, and a code for determining the presence of a user event; and the structured language is selected from the group consisting HTML, XHTML, XML, SGML, and Java.

According to the present invention, there is provided a control method allowing a portable terminal connected to at least a network and including a CPU to communicate with an external device, the portable terminal including a data acquiring section, a processing section, and an external-communication processing section, the control method causing the portable terminal to perform the steps of: reading, by the data acquiring section, data from a recording medium located externally to decode it, providing code files in a structured language, and storing the code files; reading specified one of the code files in response to a user event, executing the code file, and driving the external-communication processing section to communicate with an external device in accordance with a communication protocol specified by the code file in response to the user event.

In the present invention, the reading by the data acquiring section data from a recording medium located externally includes the step of using a CCD, a photosensor, or a magnetic sensor to read the data contactlessly. The read data in the present invention is a two-dimensional code data or magnetically recorded data from which a structured language code file is generated. The data reading step reads, from the data recording medium, data providing a data declaring code, a graphical user interface code, and a code for determining whether there is a user event, and a communication protocol specifying code. The decoding step includes the step of providing, from the read data, a code file in a structured language selected from the group consisting of HTML, XHTML, XML, SGML, and Java. The step of causing communication with the external device includes the step of communicating with the external device through a wired network, a wireless network or an infrared network.

According to the present invention, there is provided a device-executable program for causing a portable terminal to perform the control method described above.

According to the present invention, there is provided an information processing system that processes information on demand, including: a recording medium containing coded data including a data declaration, a determining function, and specification of a communication protocol; and a terminal which reads data from the recording medium, decodes said data into a code file in a structured language including a data declaring function, a determining function and a communication protocol specifying function, stores a plurality of the code files, reads a code file selected by a user event, and communicates with an external device by using a specified communication protocol.

The recording medium of the present invention is a printed two-dimensional code or a two-dimensional code or an IC tag displayed on a display screen. The terminal in the present invention includes: an input device including a CCD, a magnetic sensor, or a photosensor; a CPU which decodes the data to convert into a code file in a structured language and stores the code file in a memory device; and an external-communication device which establishes communication with an external device in accordance with a communication protocol specified by the code file. The terminal in the present invention changes the communication protocol according to data read from the recording medium.

According to the present invention, there is provided a non-contact, device-readable recording medium on which data is recorded, the data specifying a communication protocol to be used in communication with an external device after being read by the device.

According to the present invention, there is provided a portable terminal connected to at least a network, including a processing section and a display function section, wherein the processing section reads coded data including a data declaration and a determining function from a non-contact readable recording medium in response to a user event, generates a code file, provides a code file in a structured language, and controls the display function section to execute or delete the code file in response to a user event.

### BRIEF DESCRIPTION OF THE SEVERAL VIEWS OF THE DRAWINGS

FIG. 1 shows a general view of an embodiment of a network system including a non-contact medium and a portable terminal according to the present invention;

FIG. 2 shows an embodiment of a non-contact medium used in the network system 10 according to the present invention;

FIG. 3 shows an embodiment in which a portable terminal reads data recorded on a non-contact medium according to the present invention;

FIG. 4 shows an embodiment of a device-executable code file obtained from an QR code through decoding;

FIG. 5 shows a hardware configuration of a portable terminal according to the present invention.

FIG. 6 is a functional block diagram of the terminal according to the present invention;

FIG. 7 schematically shows a software configuration of an application program according to the present invention;

FIG. 8 is a diagram illustrating a configuration and dataflow in functional modules in an implementation in which a structured language program executing section or a Java program executing section can be selected and executed according to the present invention;

FIG. 9 is an outline flowchart of a process performed by an API according to the present invention;

FIG. 10 is a flowchart illustrating in detail a process performed by the API 70 provided by the present invention;

FIG. 11 is an outline flowchart of a process performed by the structured language program executing section which received a code file;

FIG. 12 shows an embodiment of a code file (pseudo code) obtained by decoding data which can be contained in a non-contact medium into XML according to the present invention;

FIG. 13 shows an embodiment of a Java code which can be used with the present invention;

FIG. 14 shows a specific pseudo code of a program read from a non-contact medium according to the present invention;

FIG. 15 shows a pseudo code describing a process for displaying a user interface for requesting a quote according to the present invention;

FIG. 16 shows an embodiment of a pseudo code for providing another GUI provided by the present invention and a transmission protocol specification;

FIG. 17 shows an embodiment of a GUI displayed by an API provided by the present invention by using the structured language program executing section contained in a portable terminal;

FIG. 18 shows a GUI presented to a user during a save or delete operation;

FIG. 19 shows a GUI displayed when a code file read from a non-contact medium and stored in a memory device is executed on the structured language program executing section;

FIG. 20 shows an embodiment of a method for controlling a portable terminal according to the present invention; and

FIG. 21 shows another embodiment of the control method according to the present invention.

### DETAILED DESCRIPTION OF THE INVENTION

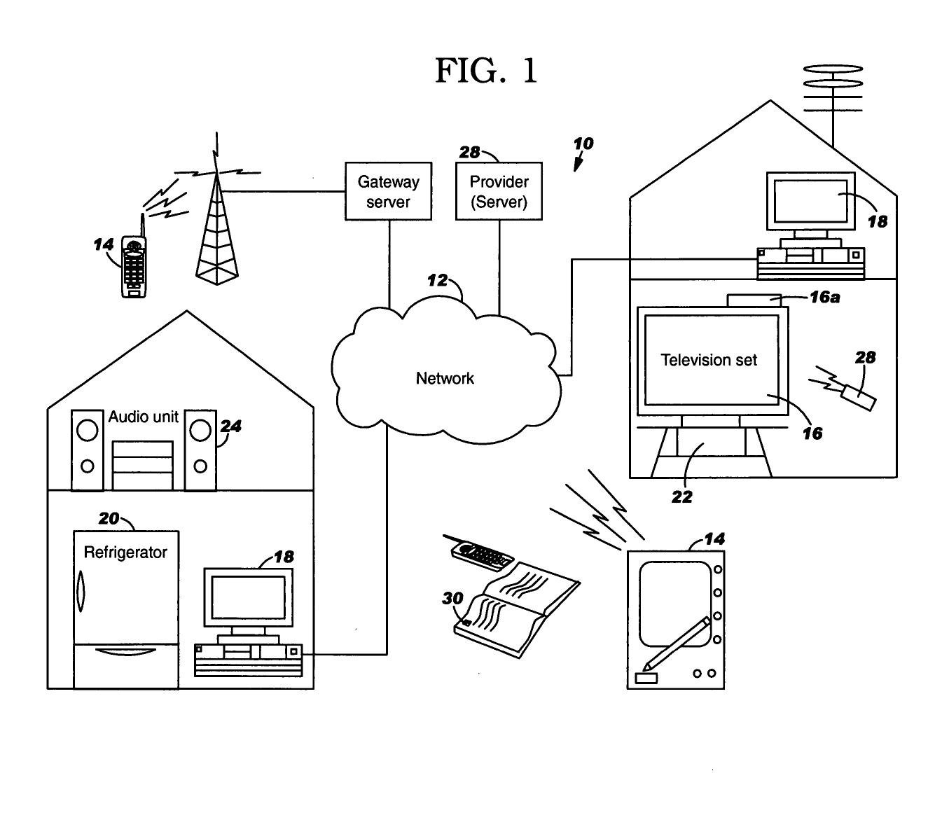

The present invention will be described with respect to specific embodiments shown in the accompanying drawings. However, the present invention should not be construed as being limited to the embodiments described below. FIG. 1 schematically shows an embodiment of an information processing system including a non-contact medium and a portable terminal according to the present invention. A network system 10 of the present invention includes a network 12, a portable terminal 14 such as a mobile phone, PDA, and PHS (Personal Handy Phone), connected to the network 12 over a wireless link, and a television set 16. The television set 16 may be installed at the home of a user of the network system 10 of the present invention.

The television set 16 may be one that can receive digital broadcast signals. In that case, a set-top box 16a may be provided separately from the television set 16. A remote controller 26 can be used to turn on/off or control sound volume of the television set 16. A personal computer 18, a refrigerator 20, a video unit 22, and an audio unit 24 are also provided at the user's home and provide their functions to the user. The television set 16, video unit 22, set-top box 16a can be controlled by instructions from their remote controllers to provide functions to the user.

Connected to the network 12 is a provider 28 that provides contents and utilities to the user. The provider 28 provides services to the user through a server. Providers herein include not only those that provide contents but also manufacture providing and servicing products and server computers hosted by them. The provider 28 can receive access from the user through the portable terminal 14. The network 12 herein may include any combination of networks that establish a communication through a communication infrastructure such as a public phone network, an ISDN network, a fiber-optic, wireless, infrared, or a satellite communication and using TCP/IP or UDP or an infrared communication protocol.

In the network system 10 shown in FIG. 1, typically the portable terminal 14 causes an application program to be executed to read data from a non-contact medium 30. Then, the portable terminal 14 uses a communication protocol specification contained in a code file converted from data, which is a packet transmission using the Internet in the embodiment shown in FIG. 1, to access the provider over the network 12. In the present invention, the portable terminal 14 does not access the provider in an one-way manner by reading a non-contact medium, but rather the provider 28 also can display the non-contact medium on the display of personal computer 18, television set 16, video unit 22, and audio unit 24. In that case, data on the non-contact medium displayed on the portable terminal 14 may be used to control the portable terminal 14 to enable bidirectional communication between the provider and the user. The present invention is not limited to portable terminals. According to another embodiment of the present invention, the present invention can also be configured as a terminal attached to a device that activates an appropriate device driver on the portable terminal 14 according to a read code file to control an external device such as an external-communication device, an external memory device, a printer, a production line device, an industrial or toy robot by using an appropriate communication protocol.

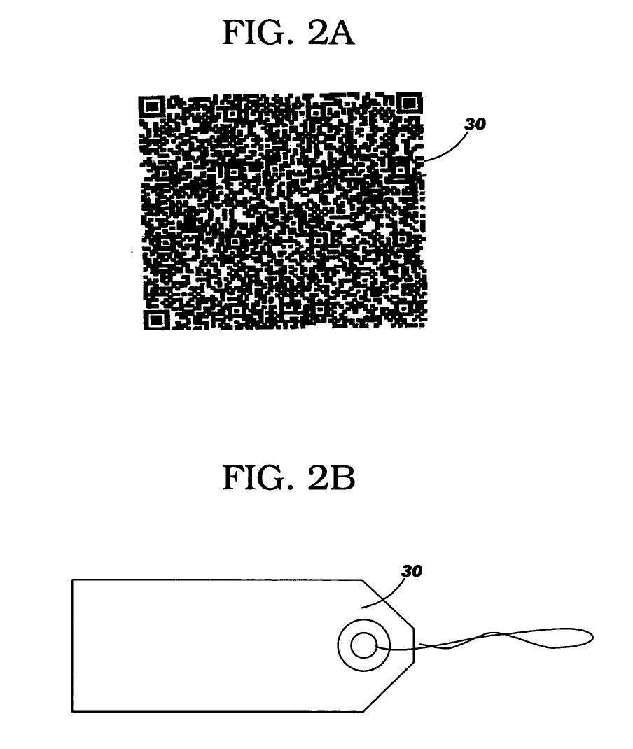

FIG. 2 shows embodiments of a non-contact medium used in the network system 10 of the present invention. FIG. 2(a) shows a non-contact medium formed as a QR code consisting of dots scattered in a two-dimensional space; FIG. 2(b) shows a non-contact medium formed as an IC tag which may be a cardboard containing a magnetic recording material. The non-contact media shown in FIG. 2 includes data declarations, GUI functional means, a determine process function, and a communication protocol specifying function in an appropriate format. For a portable terminal to obtain data from these non-contact media, it recognizes a reflectance pattern, gray-scale image, magnetic pattern, or luminance image provided by a non-contact medium and temporarily stores it in a memory in the portable terminal. Then an application program in the portable terminal decodes the data it obtained into an application-executable code file and stores the file in a memory area. Any of known coding and decoding schemes can be used for coding and decoding data on non-contact media.

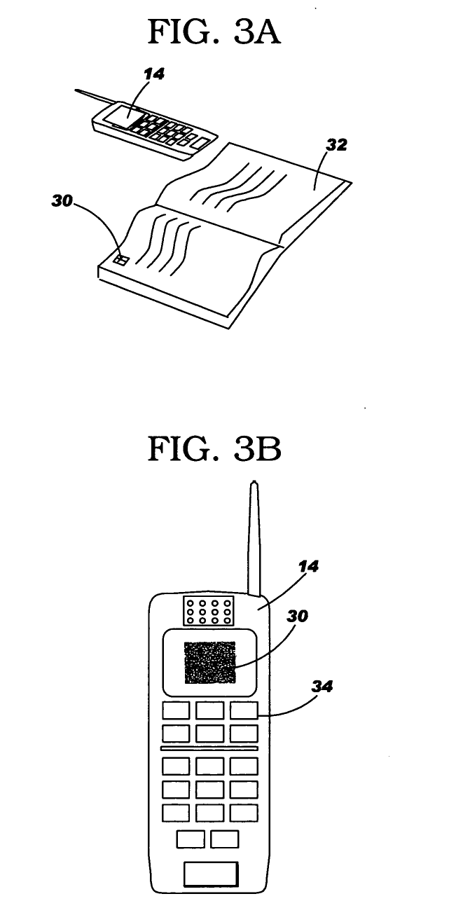

FIG. 3 shows an embodiment in which a portable terminal reads data recorded on a non-contact medium according to the present invention. In the embodiment shown in FIG. 3, the portable terminal 14 is a mobile phone with camera including a CCD and the non-contact medium is a QR code 30 printed on a page of personal computer manual 32, for example. When the user wants to obtain data, the user activates an application program and issues a read instruction on the GUI as shown in FIG. 3(a). Then the user brings the portable terminal 14 close to the QR code 30 printed on the page of the manual 32 to take a picture of the QR code 30 with the camera provided in the portable terminal 14.

FIG. 3(b) shows the portable terminal 14 after it takes the picture of the QR code 30 provided on the page of the manual 32 and temporarily stores it. Here, portable terminal 14 may store the QR code 30 as an image file, for example. Any known image file formats can be used with the present invention, including a bit-map, JPEG, GIF, PICT, TIFF, and metafile formats. Contained in the portable terminal 14 is a structured language program executing section capable of reading and executing codes written in a structured language such as HTML, XHTML, XML, SGML, and Java.

There may be various methods to convert the QR code data into a code file that can be executed by the application program. In one method, after obtaining the QR code 39 as a GIF file, the user can activate an input button 34 on the portable terminal 14 to initiate decoding of the image data of the QR code 30. This decoding converts the two-dimensional pattern temporarily stored in the portable terminal 14 into a code file that can be executed by the application program. In another embodiment of the present invention, the decoding can be started automatically on completion of reading of data without requiring any user instruction.

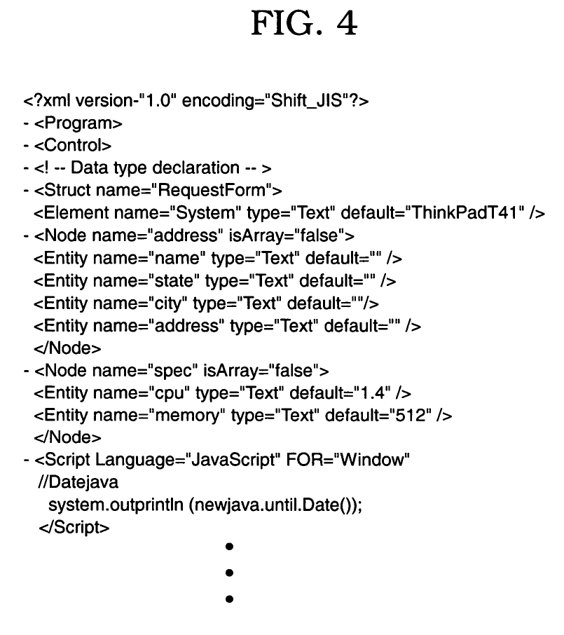

FIG. 4 shows an embodiment of a device-executable code file obtained from the QR code 30 by the above-described decoding. The code file shown in FIG. 4 may be written by a provider, for example a compute manufacture/distributor, an electric appliance manufacture/distributor, a content provider, or a broadcaster that wants to provide services to the user, embedded in the non-contact medium, and distributed to the user, or displayed on a display screen to provide it to the user.

FIG. 4 shows only a portion of a pseudo code for illustrative purpose only. Data declarations, GUI functions, determination functions, and communication protocol specifying functions that are necessary for the portable terminal 14 to perform processing are recorded on the non-contact medium according to the present invention. The embodiment of the code file will be described later in detail. The series of operations described above enables the code written by a computer manufacturer/distributor, an electric appliance manufacturer/distributor, or a content provider to be made available to the user through the non-contact medium. Here, in addition to the data, image data for presenting an appropriate graphical user interface as well as code for the communication control function of the portable terminal 14 is also provided to the user. Accordingly, the user can receive services or functions intended by the computer manufacturer/distributor, electric appliance manufacturer/distributor, or content provider simply by reading the data from the non-contact medium. Such services or functions include, but not limited to, product repair services, remote control functions, requested contents, questionnaires, and audience rating surveys.

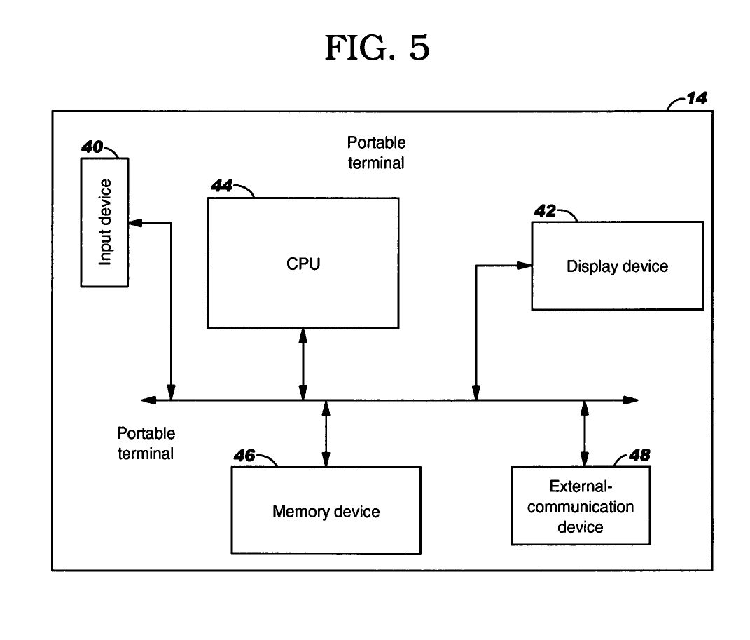

FIG. 5 shows a hardware configuration of the portable terminal 14 according to the present invention. The portable terminal 14 is configured as a portable information processing terminal such as a mobile phone, PDA, or a PHS. It typically includes an input device 40, a display device 42, a central processing unit (CPU) 44, and a memory device 46 including non-volatile and volatile memories. The input device 46 may be input means such s a input buttons, a keyboard, or a touch panel through which data is input through a direct touch by a user, as well as a CCD, a photosensor, or a magnetic sensor. The portable terminal 14 according to the present invention reads data from non-contact media in response to an input by a input button and also performs other functions such as telephone call, mail communication, URL browsing, and infrared communication functions included in the portable terminal 14 in accordance with a user's selection or a provider's specification. The display device 42 is typically implemented by a liquid-crystal-display device, a plasma display device, or an electroluminescence device, and presents the GUP provided by the present invention to the user and provides various displays required for other functions to the user.

The CPU 44 reads the application program of the present invention from a memory device 46 in response to a user instruction and performs processing. It provides an appropriate user interface to the user and controls an external-communication device 48 to transmit and receive requests/response to and from an external device. The external-communication device 48 may be an infrared transceiver, a wireless transceiver, or a wired transceiver, but not limited to these in the present invention. The external-communication device 48 provides intercommunication between the portable terminal 14 and an external device. These devices are interconnected through an internal bus line for communicating data.

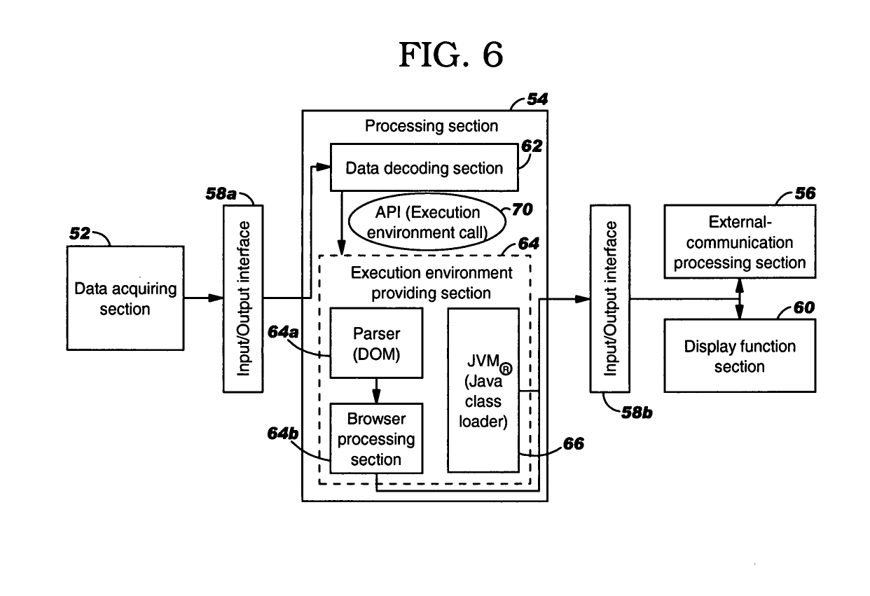

FIG. 6 shows a functional block diagram of the terminal 14 according to the present invention. The functional units shown in FIG. 6 are implemented by devices within the terminal 14 under the control of a CPU (not shown). The terminal 14 according to the present invention includes as its functional units a data acquiring section 52, a processing section 54, an external-communication processing section 56, input/output interfaces 58a and 58b, and a display function section 60. The data acquiring section 52 acquires data through the use of a CCD, photosensor, or magnetic sensor from non-contact media such as a QR code and stores the data in a memory (not shown).

The processing section 54 in the present invention includes a data decoding section 62 and an execution environment providing section 64. The data decoding section 62 decodes data in response to a user instruction or automatically on the completion of writing to the memory device 46 to generate a code file, for example, in a device-executable format. It is assumed in the following description that the code file is written in XML. The decoded code file is stored in the memory device 46 shown in FIG. 5 in the specific embodiment of the present invention. At the same time, an identifier such as “LCD television remote controller” can be assigned to the code file. Every time a new code file is entered, its identifier can be added to a code list.

The execution environment providing section 64, which is implemented as a parser 64a (DOM) in the specific embodiment shown in FIG. 6 according to the present invention, acquires a structured language such as XML, and has the capability of activating the browser processing section 64b to provide a GUI. In another embodiment of the present invention, the execution environment providing section 64 may include a Java program executing section 66 so that a program written in Java can be directly activated. In yet another embodiment of the present invention, the execution environment providing section 64 can be read directly into the external-communication processing section 56 without using the browser processing section 64b, and transmits a converted code file to an external device without using any display function. According to the present invention, the execution environment providing section 64 can be implemented so as to only one of, or all of, or any combination of the functional blocks described above.

A code file selected by the user is received from the memory device 46, and the elements of the code file are sequentially interpreted and provided to the browser processing section 64b. The browser processing section 64b receives the code file, activates the display function section to cause it generate GUI displays according to the code file. The browser processing section 66 responses a user event by causing the external-communication processing section 56 to initiate communication using a communication protocol suitable for a service desired by the user.

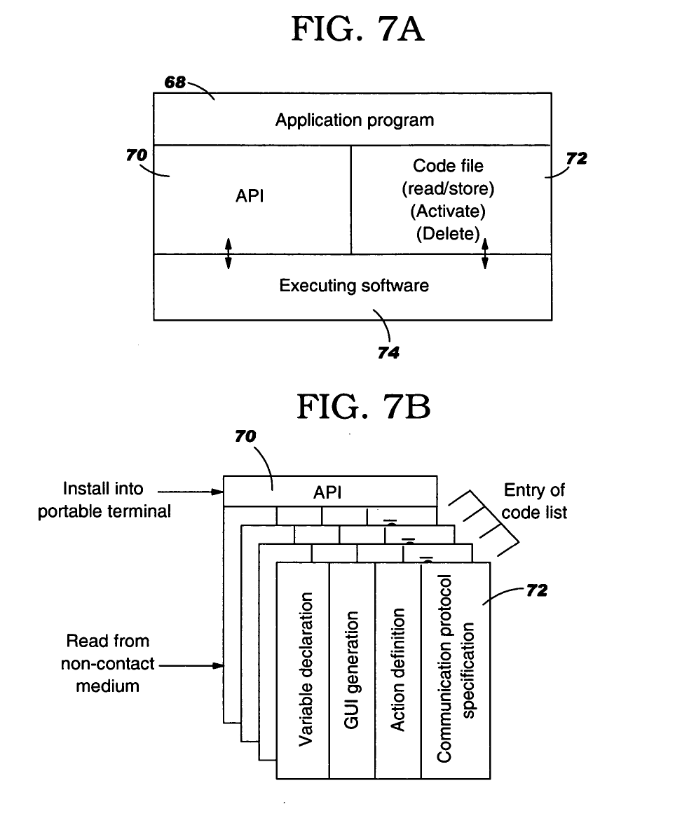

FIG. 7 schematically shows a software configuration of the application program according to the present invention. FIG. 7(a) shows a general configuration of the application program 68 of the present invention; FIG. 7(b) shows the relationship between an application programming interface (API) 70 and a code file 72 included in the application program 68. As shown in FIG. 7(a), the application program 68 of the present invention includes the API 70 which controls the reading of data from non-contact media and the activation and deletion of the code file, and an executing software 74. The executing software 74 in the present invention can be implemented as a structured language program executing section, a Java program executing section, or communication software, depending on the functions of the execution environment providing section 64. Any of these executing sections may be implemented as by itself or any combination of these executing sections may be implemented on the portable terminal 14. When being activated, the API 70 activates appropriate executing software 74 to display a GUI from which a user can make a selection, or activate a Java program, or set a communication port as active.

An example in which the executing software 74 is a structured language program executing section will be detailed with respect to user input data. When a user enters data as the user is prompted through a GUI, the structured language program executing section responds to it by providing the user instruction to the API 70. In response to the user instruction, the API 70 activates a sensor driver or indicates the code file 72 selected by the user to the structured language program executing section and causes it process the code file. These software are stored as software module in the portable terminal 14. If no code file is loaded in the present invention or all code files installed are deleted, only the API 70 and the executing software are on the portable terminal.

FIG. 7(b) shows the relationship between the API 70 and a code file 72 called by the API 70 according to the present invention. The API 70 includes a code list, in which pairs of code file names and their identifiers constitute entries of a data table. A code file name may have any format, provided that it can specify a code file stored in the memory device. An identifier may be specified by the user and used for the sake of clarity of the associated code file when presented on the GUI to the user. The API 70 and the executing software 74 in the present invention may be stored on a ROM in the portable terminal. The code files 72 are stored in a memory that is rewritable as needed so that they can be added or deleted on demand.

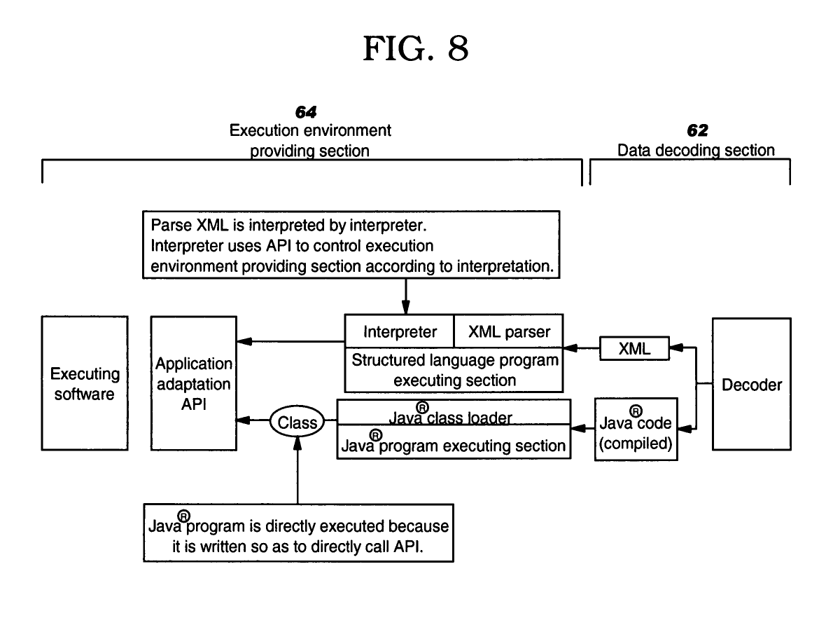

Referring to FIG. 8, a process will be detailed below in which the API 70 activates a structured program executing section or Java program executing section as the executing software 74. FIG. 8 shows a specific embodiment in which the functional units corresponding to those in FIG. 7 are implemented.

(1) For Running a Structured Language Program Execution Section:

First, a non-contact medium, which may be a QR code or IC tag, is scanned by using the application program of the present invention. Then, the scanned data is decoded into text. For this purpose, any of known scanners and APIs for scanning may be used with the present invention. The resulting text is then parsed into XML. As the resulting XML code is interpreted by an interpreter (browser processing section) included in the execution environment providing section, an execution environment is provided. Then, an API is called as needed and the execution environment providing section 64 performs a process according to the program described in the XML code.

(2) For Running a Java Program Executing Section:

The Java code executed in the embodiment must have an extended base class specified by the execution environment providing section 64. It is also required that a program required for the Java code to operate as a desired application be written in the Java code by using an appropriate API provided by the execution environment providing section 64.

In practice, the non-contact medium is scanned as describe above and the scanned data is decoded into a Java byte code. The resulting Java byte code is then read by a Java class loader (included as a function of the Java program executing section) into the execution environment providing section 64 as a Java class. The Java program executing section in the execution environment providing section 64 is implemented as a program module written in a Java code in such a manner that a class which is read and meets a prerequisite can be directly executed as a program which controls the portable terminal. Accordingly, the execution environment providing section 64 calls an appropriate method as needed and executes the read class to implement operations of the desired application.

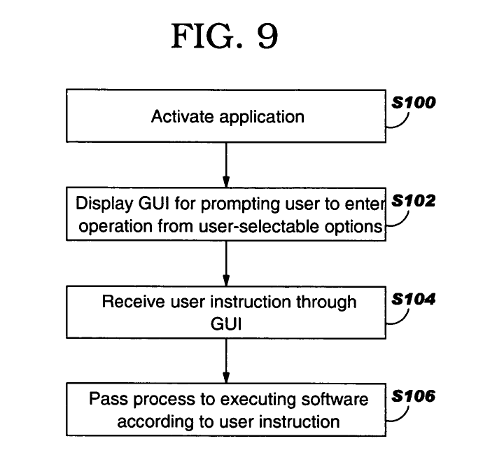

FIG. 9 shows an outline flowchart of a process performed by the API 70 according to the present invention. As shown in FIG. 9, the API 70 of the present invention is activated in response to a user request at step S100 and causes a GUI to be displayed that prompts the user to enter a desired operation at step S102. At step S104, an instruction is received from the user through the GUI. Then, the process proceeds to step S106, where the operation specified by the user is identified, a sensor driver is activated, and a code file is read into the executing software.

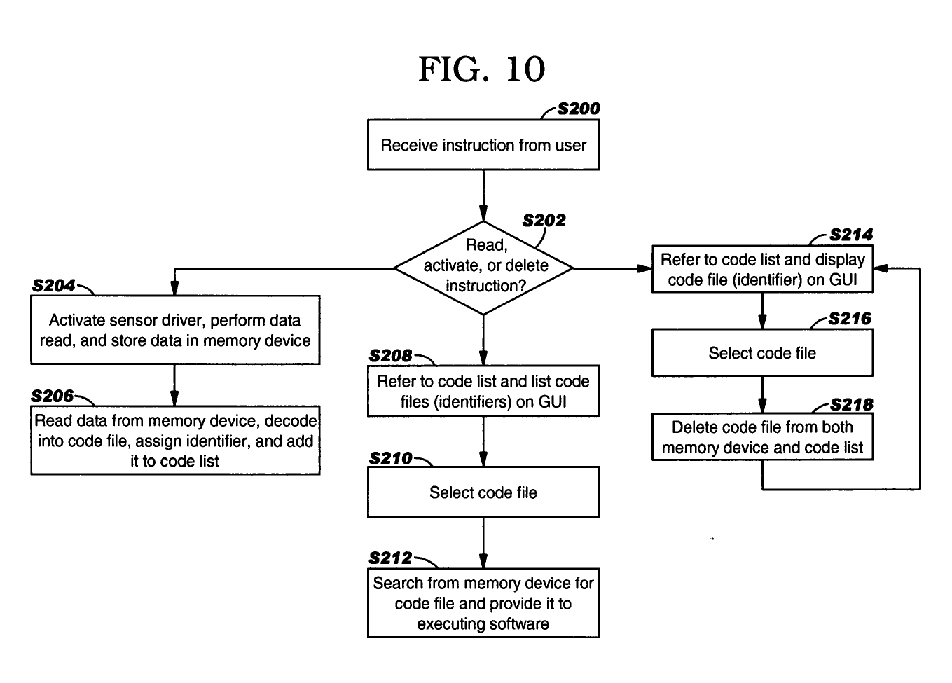

FIG. 10 is a flowchart showing in detail the process performed by the API 70 provided by the present invention. The API 70 of the present invention receives a user instruction through the GUI at step S200 and determines which of the operations, read, activation, or deletion, is specified by the user instruction at step 202. According to the determination, a read operation at steps S204 to S206, activation at steps S208 to S212, or deletion at steps S214 to S218, is performed.

If it is determined at step S202 that the user instruction indicates a read, then the API 70 activates a sensor driver such as a CCD or a magnetic sensor to read data from the non-contact medium and stores it in the memory device at step S204. At step 206, the data is readout, decoded into a code file, which is added to a code list together with its identifier. At this point, the new code file is stored in the portable terminal.

On the other hand, if the user instruction is an activation instruction, then the API 70 refers to the code list and lists code files (or their identifiers) on the GUI at step S208. The API 70 prompts the user to select a code file on the GUI at step S210 and searches the memory device for the selected code file at step S212 and provides it to the executing software. If the user issues an instruction to delete a registered code file, the API 70 refers to the code list and lists code files (their identifiers) on the GUI at step S214. At step S216, it prompts the user to select a code file. Then, it deletes the selected code file from both the memory device and the code list in response to a user event at step S218 and the process returns to at step S214, where the result is presented to the user.

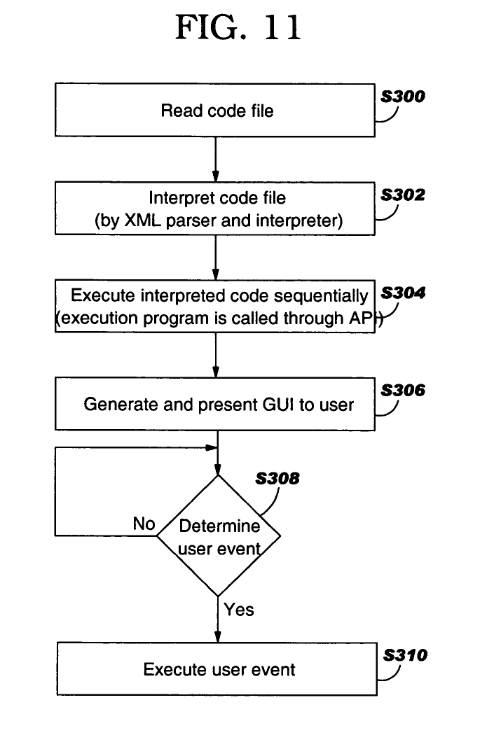

FIG. 11 is an outline flowchart of a process performed by the executing software which received the code file. Here, it is assumed that the executing software is the structured language program executing section. As shown in FIG. 11, the structured language program executing section read a code file at step S300 and interprets the code file at step S302. Then, the interpreted code is executed in a sequential manner at step 304. AT step S306, a GUI is generated on the display device and presented to the user. At step S308, determination is made as to whether there is a user event. If there is a user event (YES), then the user event is executed at step S310. If there is no user event at S308 (NO), then the process returns to step S308, where the structured language executing section waits for a user instruction until there is a user event.

If the executing software is the Java program execution section, that is, if it is a JVM including a Java class loader as a function, a Java code in compiled format is held on a recording medium as shown in FIG. 8. The API 70 determines based on a variable declaration, for example, that it is a Java code, and activates the Java program executing section (typically implemented as a JVM) to execute the Java code. If the executing software performs communication with an external device independently of the display function, then a code that directly instructs the software to communicate with an external device may be included in coded data stored in the storage medium without writing a code portion for providing a GUI, and the API 70 may be caused to set a communication port to active when the API 70 stores the code file. The executing software that performs the specific process described above is not limited to the structured language program executing section, the Java program executing section, and communication software. Any other software may be used as the executing software in the present invention.

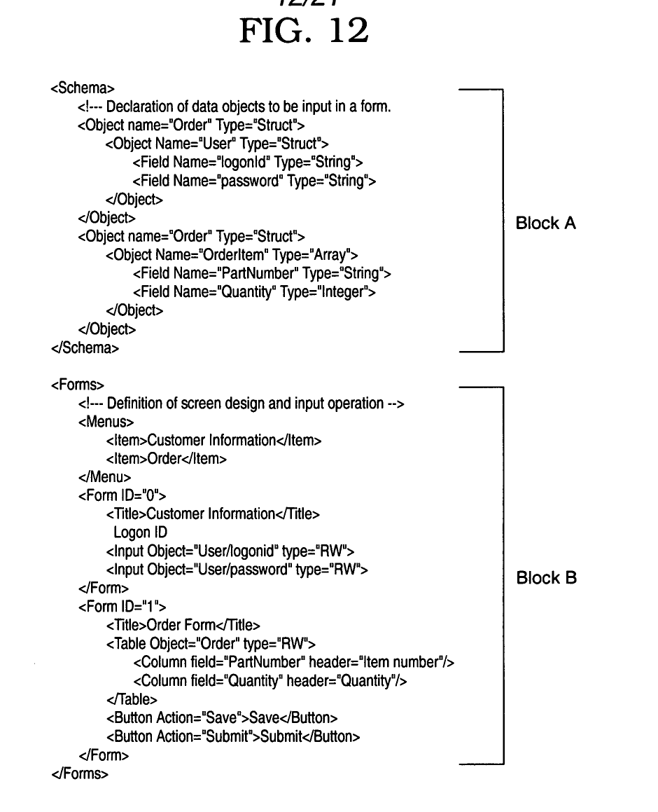

FIG. 12 shows an embodiment (pseudo code) of a code file which is obtained by decoding data which can be included in a non-contact medium into XML according to the present invention. The pseudo code shown in FIG. 12 include a data declaration defining inputs and an input procedure, a GUI function for prompting for input, a code for allowing for determination as to input data, and a code for specifying a communication protocol. A provider writes these in XML, encodes through compression as appropriate, transforms it to a non-contact medium, and distributes it to user as a printed matter or a screen display.

The pseudo code shown in FIG. 12 will be further described. In block A, data objects to be input by a user is declared. In block B, a code for providing a GUI for performing input and submit actions is written. Furthermore, user actions are described by <Button Action>. These actions are performed by the commands defined for buttons displayed on the screen.

The code shown in block C in the pseudo code in FIG. 12 is portion in which actions defined in response to user operations. Actions “Save” and “Submit” are defined. Also described in block C are an operation to be performed if the length of the order form is null and an operation if a user ID and password are not entered. It is indicated that unless these conditions are met, the submit action is not completed. Described in the pseudo code portion in block D in FIG. 12 are communication protocol specifications such as a communication protocol, a destination URI address, and user parameter specifications so that the filled in form can be transmitted to the destination URI address. In the present invention, the communication protocol can be described as a wireless or infrared communication and the URI address can be described as the URI address of a device that supports the communication protocol and thus the present invention can be applied to any devices.

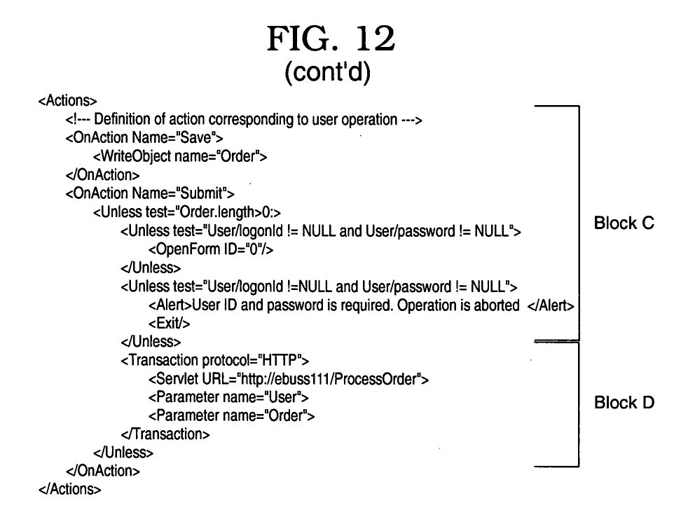

FIG. 13 shows an embodiment of a Java code that can be held as a code file in a non-contact medium. The Java code shown in FIG. 13 can be transformed into a compiled format, encoded into a QR code, and stored in a non-contact medium by a provider. A portable terminal 14 reads the data from the non-contact medium 30, decodes it, and stores the decoded data. Then, if the portable terminal 14 determines that the code file it has read is a Java code, the portable terminal 14 executes “createUI” included in its Java program executing section to generate a GUI directly from the Java code. User events such as a selection and input through a user display screen are passed to an action method included in the Java program executing section and a sequence of operations is performed.

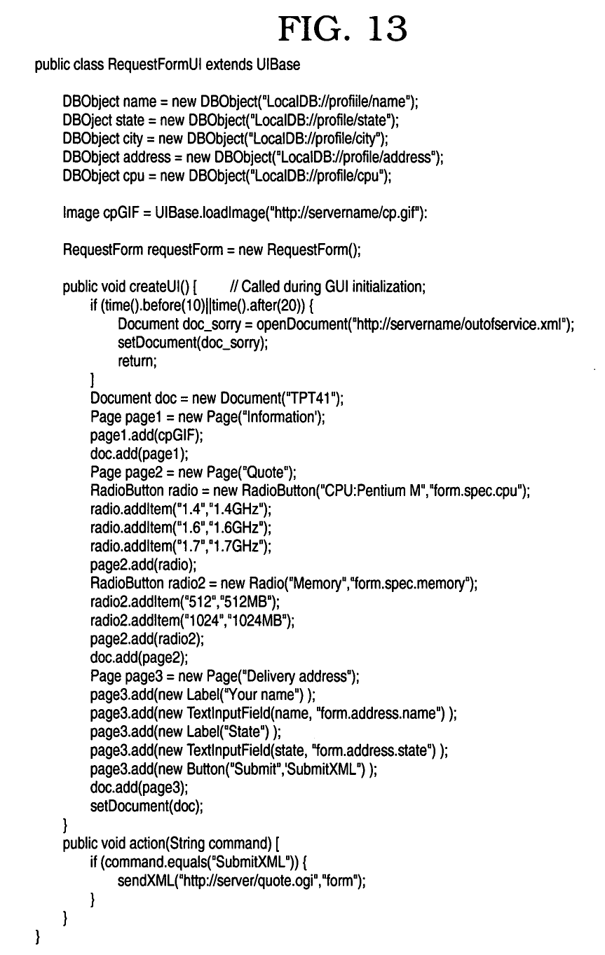

FIG. 14 shows a more specific pseudo code of a program read from a non-contact medium in the present invention. The pseudo code shown in FIG. 14 is a code that provides a control function for allowing a portable terminal to perform a request for a quote of personal computers. A data type declaration and initialization variables are described. First data structure names are declared in block A and variables are initialized in block B.

In block C, a process is caused to executed in which service conditions are set and, if the service conditions are met, the portable terminal is allowed to access the predetermined URI address; otherwise an XML file is displayed for indicating an out-of-service state.

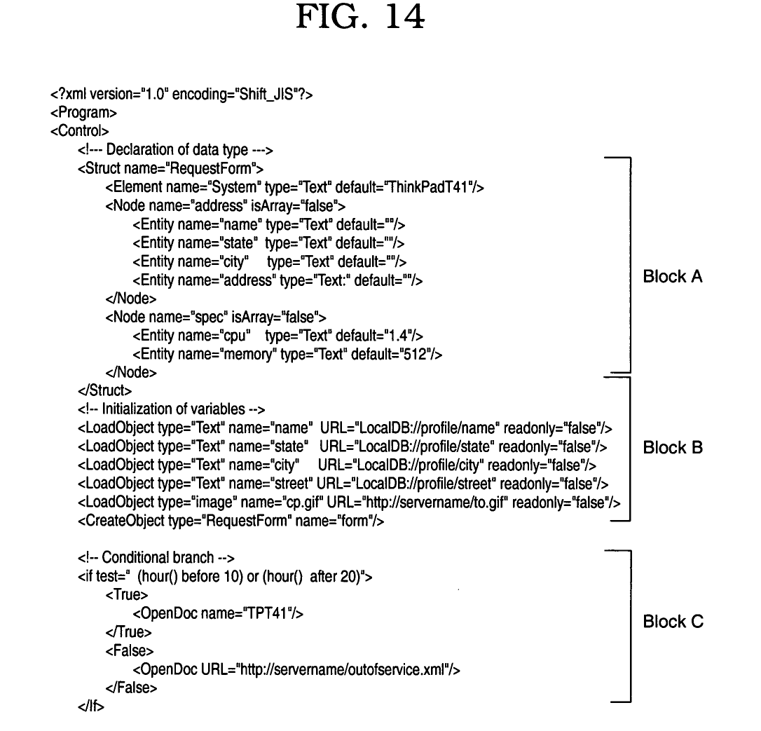

FIG. 15 shows a pseudo code describing a process for displaying a user interface for requesting a quote in the present invention. First, <Document name=“TPT41”> is used to specify a page and “Information” and imaged data are caused to be displayed. Then, a title, “Quote,” is caused to be displayed and a GUI for allowing a user to select a model and specify a hardware component is created with the <RadioButton> command. The user can fill in the page as guided by the GUI displayed by the pseudo code shown in FIG. 15 through the structured language program executing section.

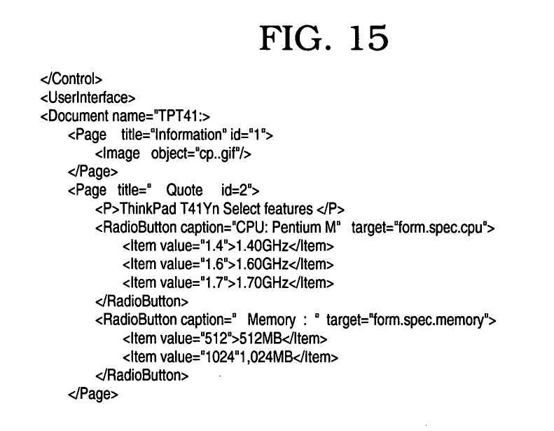

FIG. 16 shows an embodiment of a pseudo code for providing another GUI and transmission protocol specification according to the present invention. The first portion from “<P>customer information</P>” to “<P>street</P>” of the pseudo code shown in FIG. 16 causes a GUI to be displayed that prompt a user to enter customer information. The displayed GUI will prompt the user to enter user's name, state, city, and street. In the second portion of the pseudo code, a submission operation and a communication protocol are specified with elements such as http and CGI. In particular, it is specified that when the user select a button labeled with “Submit,” form data entered is converted into XMl and sent to the server at the predetermined URI address “http://server/qoate/cgi/” using CGI by packet communication. When receiving the form data, the server processes the data received in XML and returns the requested quote data to the user. According to the present invention, other commands such as “mailto:” and “enctype:” and method attributes such as “get” and “post” can also be specified as appropriate.

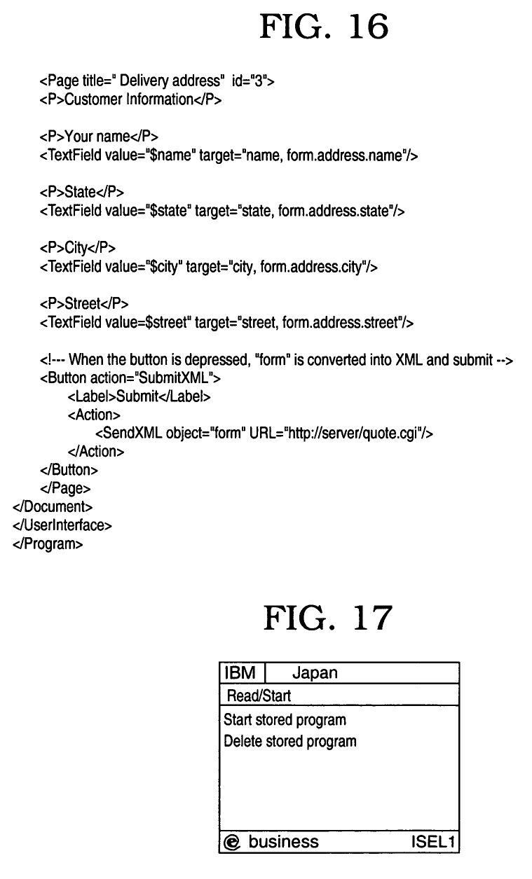

FIG. 17 shows an embodiment of a GUI displayed by an API provided by the present invention trough the use of the structured language program executing section included in a portable terminal. When the user activates an application program, the API 70 is activated and the initial screen is displayed as shown in FIG. 17. On the initial screen, menu options such as “Read/Activate,” “Activate stored program,” and “Delete stored program” to enable to read from non-contact medium for the user is provided. When the user positions a cursor on a desired menu option and presses a button, the corresponding process is activated. To provide this display, for example a code list may be referred to and the following pseudo code included in API 70 may be used.

<Select name = “procedurelist” size 3>

<Option value= “readstart” > Read/Activate </Option>
<Option value= “start” > Start stored program </Option>
<Option value= “delete” > Delete stored program </Option>

<Select>.

In the pseudo code shown above, if the user selects the “Read/Activate,” then “readstart” is indicated to the API. When receiving the indication, the API finds an appropriate sensor driver to activate it and executes a read from the non-contact medium for the user. If the user selects “Save stored program” or “Delete stored program,” the API activates a save process (SaveCommand event) or a delete process (DeleteCommand event) for the user to update the memory device and the code list through the structured language program executing section.

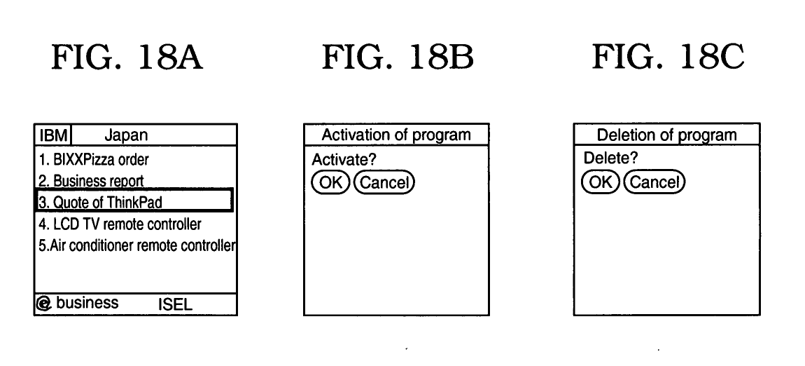

FIG. 18 shows a GUI provided to the user during a save or delete operation. FIG. 18(a) shows a GUI on which code files contained in a code list; FIGS. 18(b) and 18(c) show GUIs displayed after the user selects the option “3. ThinkPad quote.” The GUI in FIG. 18(b) prompts the user to activate a stored program and the GUI in FIG. 18(c) prompts the user to delete a stored program. The user can perform input operations as guided by these GUIs shown in FIG. 18 to execute or delete the code file with the code file name that the user specified. The GUI shown in FIG. 18(a) can be generated by using the following pseudo code included in the “start” code, for example.

```
<Select name=codelist>
  <Option value = “BIXXXPizza”>1. BIXXXPizza order </Option>
  <Option value= “BusinessReport”>2. Business report</Option>
  <Option value= “evalTPD”>3. Quote of ThinkPad </Option>
  <Option value= “TVRemote”4. LCD TV remote controller </Option>
  <Option value= “A-CONRemote”5. Air conditioner remote
  controller </Option>
<Select>
```

According to the pseudo code shown above, “3. Quote of ThinkPad” is presented to the user and, when the user selects it, text data in “evalTPD” is provided to the API 70. When receiving the “evalTPD” code, the API 70 finds the code file provided in the pseudo codes shown in FIGS. 15 to 17 from the memory device, provides it to the structured language program executing section to execute it, thereby performing the process.

The following is an embodiment of a pseudo code that can be used for providing the GUI shown in FIG. 18(b) to the user.

<style type= “text/ccs”>
<th#sample1> {background-color:#808080}
<tr><tr id= “sample1”> Activation of program </tr>
Activate?
<Input type= “submit” name=“send” value= “OK”><Br>
<Input type= “reset” name= “reset” value= “Cancel”><Br>
<Br>

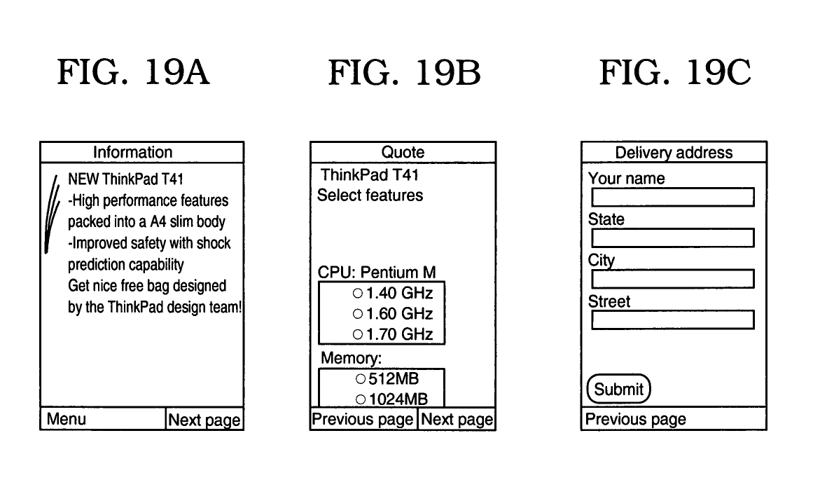

FIG. 19 shows a GUI displayed when a code file read from a non-contact medium and stored in the memory device is executed on the structured language program executing section. FIG. 19(a) shows a Web page containing an image file displayed when accessing the code file. Clicking “Next page” displays the “Quote” page shown in FIG. 19(b). On this page, the user can selects a radio button to specify a model. When the user clicks “Next page,” the user information registration page shown in FIG. 19(c) is displayed. After entering information such as a user name on the page shown in FIG. 18(c), the user selects the “Submit” button (which corresponds to the process from <label> to </Action> in FIG. 16) to send the form data to the server. Then, the server can calculate the quote and return the result to the user's portable terminal to provide the quote to the user.

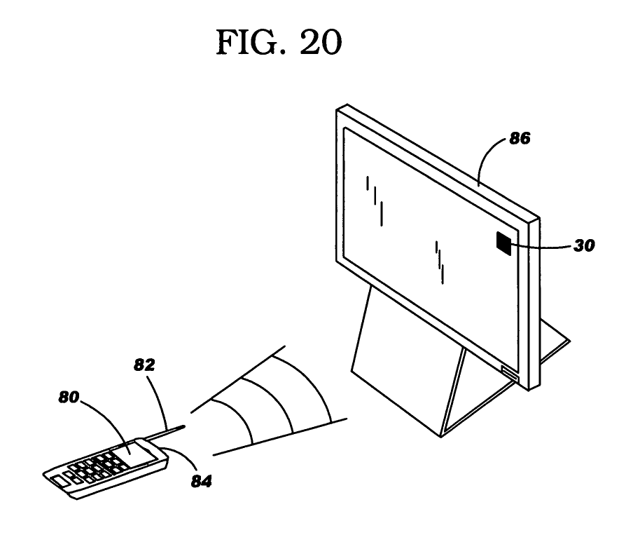

FIG. 20 shows another embodiment of a method for controlling a portable terminal according to the present invention. A portable terminal in the embodiment shown in FIG. 20 can be used for a remote controller of electric appliances such as a television set, air conditioner, video unit, and audio unit. A user can obtain a code file from a non-contact medium provided on an operation manual, for example, and store it in a portable terminal 80. Provided in the portable terminal 80 are wireless communication means 82 as well as an infrared communication port 84 to enable access to an external device wirelessly and through infrared communication.

A commands for controlling an electronic appliance and an infrared communication protocol, for example, for communication with the electronic appliance can be describe in a code file of the present invention. In the embodiment shown in FIG. 20, the user selects an option, for example “4. LCD TV remote controller”, displayed on a GUI. Then the portable terminal 80 calls and executes the code file, which contains necessary control codes of a liquid-crystal-display television remote controller. The user can send a turn-on signal or a sound volume control signal to a LCD television set 86 from the portable terminal 80, for example the infrared communication port 84. The LCD television set 86 senses the infrared communication signal and interprets the received signal according to the given protocol. Thus, the LCD television set 86 can be controlled. In FIG. 20, the video image of non-contact medium 30 is provided on the display screen of the LCD television set 86 from a broadcasting station or a provider. The user can use the portable terminal 80 to take a photograph of the non-contact medium and receive various on-demand services.

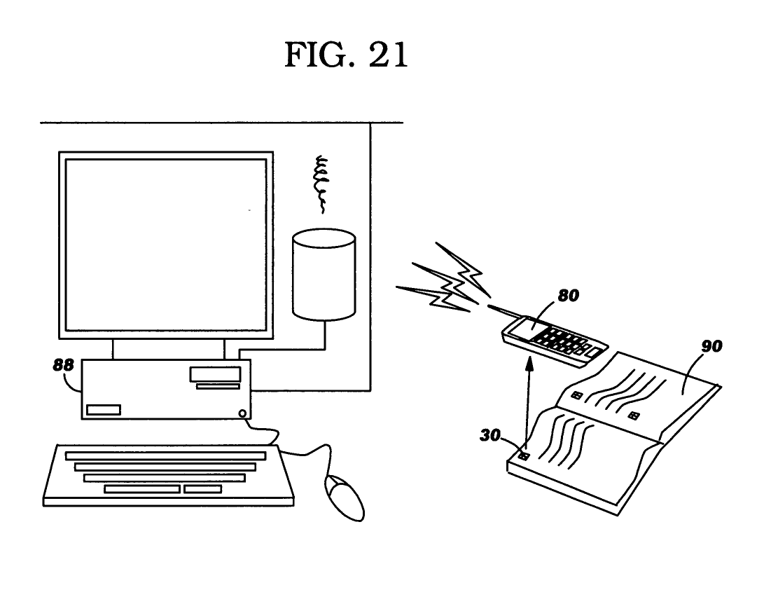

FIG. 21 shows yet another embodiment of the present invention. In the embodiment shown in FIG. 21, a user uses a portable terminal 80 to control a personal computer 88 and also make service registration with a service center. The user uses the portable terminal 80 to obtain a two-dimensional code printed in a given section on a page of an operation manual 90 to obtain control functions. Furthermore, a two-dimensional code printed in the term “Troubleshooting” contains the telephone number of the service center, the address of the server, and information required for receiving services. In the embodiment in FIG. 21, it is assumed that the personal computer has problems and the user wants to make service registration with the service center.

General users of personal computers 88 often have been having difficulty in describing problems with the personal computers 88 or experiencing inconvenience of not reaching the service center by phone or not finding the contact address when trying to access the service center. In the embodiment in FIG. 21, the user uses the portable terminal 80 to obtain two-dimensional codes contained in an appropriate section of the operating manual 90 and registers it in the portable terminal 80 as code files. Then the user selects on the GUI an option, “PC service registration,” for example, which is registered as a cod file, to activate it. Then, the user can follows instructions displayed on the GUI to sequentially read two-dimensional codes associated possible faulty portions to report the name and contact address of the user, faulty portions, the model, and symptoms and other data to the server at the service center. The server analyzes the received data and can send an inquiry to the user or notify the dates or schedule available for the service to the user.

In yet another embodiment of the present invention, an order form can be embedded in an advertisement in order to encourage a reader to do online shopping. In this embodiment, the order form is created and distributed by defining and printing it. Embedded in the form are entry fields for entering information required for an order, such as a quantity, address, and payment method, and the SKU of the advertised commodity. A process to be performed after completion of filling in the form is also described so as to transmit the data to the electronic commerce site hosted by the advertiser. When a reader (user) of the advertisement uses a portable terminal such as a mobile phone on which the application program of the present invention is installed to scan a two-dimensional code affixed to the advertisement, the order form written as the two-dimensional code is interpreted and a GUI is displayed on the portable terminal. Then, the user can enter required information by following instructions on the scanned order form through the GUI displayed on the display to order the commodity.

According to the present invention, a code for controlling a GUI can be embedded in anything in the case where interactions are required for user input. In another embodiment of the information processing system of the present invention, a terminal device can be provided that can be installed on an assembly line in a factory and adapted to unattended operation of the assembly line. In particular, non-contact media (QR codes or IC tags) are affixed to parts flowing on the assembly line. Industrial robots equipped with terminal devices of the present invention can perform the following operations on the flowing parts:
(a) Tighten the screws,
(b) Clean the parts, and
(c) Control the line destination of assemblies after being screwed.

The following QR codes are affixed to parts for the use by the industrial robots described above.

Part A Sample: QR Code (IC Tag)

(Data Declaring Section)

Information about the parts
The size and weight of the parts to be used and line destination of acceptable parts.
   (Determining Function Section)
Operation: Select a screw of a particular size and secure a part with the screw.
Determination: Determine whether the screw has been properly tightened (for example, determine the torque load on a torque wrench). If acceptable, continue the process; otherwise change the line destination to a “defective screw” section.
Operation: Clean the parts.
Determination: Determine whether the parts have been properly cleaned (for example monitor the reflection spectrum of the parts). If acceptable, continue the process; otherwise set the line destination to a “poorly cleaned part” section.
Operation: Transfer the parts to the set line destination.
   Part B Sample: Non-Contact Medium (QR Code or IC Tag)
   (Data Declaring Section)
Specify line destination for acceptable parts
   (Determination Section)
Operation: Clean the parts.
Determination: Determine whether the parts have bee properly cleaned. If acceptable, continue the process; otherwise set the line destination to a “poorly cleaned part” section.
Operation: Transfer the parts to the set line destination.

According to the present invention, the entire data required for control can be read from a non-contact medium attached to a part, the efficiency of the control can be improved. In particular, (1) there is no need for implementing control involving complicated conditional determination in general assembly line devices; (2) simply by providing a program written onto non-contact media (QR codes or IC tags), new parts can be handled with flexibility and without modification to a program for the devices; (3) functions of the devices, such as screwing and cleaning, can be selectively executed; (4) a program can be obtained from non-contact media such as QR codes without writing any program for the devices, if not necessary; and (5) supply lines for supplying required components (such as screws) can be dynamically changed according to instructions in the QR codes.

In another embodiment of the present invention, the system can be placed on a round service route and record evidences and send reports. In this embodiment, instructions relating to operations to be done in particular service locations, items to be reported after the operations, and the addresses to which the reports should be sent are contained in two-dimensional codes in forms and placed at the service locations for the use by building or railroad maintenance workers who make rounds. Thus, reports about routine services can be provided efficiently.

While the present invention has been described with respect to specific embodiments shown in the drawings, the present invention is not limited to the specific embodiments shown in the drawings. For example, the present invention can be applied to emergency call forms for vehicle, financial service forms, train/airline booking forms, entrance/exit service forms, security forms, inventory forms, and any other applications.

While the program of the present invention has been described in large part as a program encoded using XML, the present invention is not limited to XML. Any software programs that are compatible with a structured language program executing section, such as those written in HTML, XHTML, SGML, Java, Java Applet, and Java Script.

1. A device-readable recording medium for storing data and being read by a sensor in a non-contact manner, said recording medium comprising:
means for storing a data declaration section for specifying input data and content data;
means for storing a determination function section which causes a process to be executed in response to a user event; and
means for storing a communication protocol specification section.

2. The recording medium according to claim 1, wherein the data stored by said recording medium is stored as a two-dimensional code.

3. The recording medium according to claim 1, wherein said recording medium is an IC tag.

4. The recording medium according to claim 1, further comprising means for storing a code file having a structured language format,
wherein said code file includes said data declaration section, said determination function section, and said communication protocol specification section.

5. The recording medium according to claim 4, wherein said structured language format is HTML, XHTML, XML, SGM, or Java.

6. A portable terminal operably connected to a network, said portable terminal comprising:
a data acquiring section that acquires coded data from a recording medium in without physical contact between the recording medium and said portable terminal;
a display function section;
a processing section including a data decoding section that loads the acquired coded data, decodes the loaded coded data, and provides a code file in a structured language; and
an execution environment providing section that provides an environment for executing said code file,
wherein the portable terminal establishes communication with an external device in accordance with a communication protocol specified by the code file.

7. The portable terminal according to claim 6, further including an external-communication processing section for communicating with the external device in response to a user event.

8. The portable terminal according to claim 7, wherein said data acquiring section includes a CCD.

9. The portable terminal according to claim 7, wherein the acquired coded data is two-dimensional code data.

10. The portable terminal according to claim 7, wherein execution of said code file by said execution environment generates a graphical user interface in a structured language selected from the group consisting of HTML, XHTML, XML, SGML, and Java.

11. A portable terminal for communicating without physical contact with a recording media, said portable terminal operably connected to a network, said portable terminal comprising:
data acquiring means for acquiring coded data from a recording medium without physical contact therewith;
means for loading the coded data containing a data declaration and a determination process function from the recording medium; and
processor means for decoding the loaded data, generating a code file described in a structured language, storing the code file in a storage device, reading a selected code file in response to a user event for execution, and communicating with an external device via the network using a protocol specified by the selected code file.

12. The portable terminal according to claim 11, wherein said processing means includes:
means for data decoding the loaded data to provide a code file in a structured language;
an execution environment for executing code in said code file; and
means for establishing communication with an external device in accordance with a communication protocol specified in said code file.

13. The portable terminal according to claim 11, said portable terminal further comprising a display device, wherein a graphical user interface is generated by executing said code file by the execution environment and the graphical user interface is displayed on said display device.

14. The portable terminal according to claim 11, wherein said data acquiring section includes a magnetic sensor.

15. The portable terminal according to claim 11, wherein the coded data is provided as two-dimensional coded data and said processing means generates a structured language code file from the provided two-dimensional coded data; said provided coded data is converted into structured language format code including data declaring code, graphical user interface code, and code for determining an occurrence of a user event; and a structured language for the structured language format code is selected from the group consisting HTML, XHTML, XML, SGML, and Java.

16. A method for controlling a portable terminal operably connected with a network to forward data read from a remote device without contact therewith to an external device, said portable terminal including a data acquiring section, a processing section, and an external-communication processing section, said method comprising the steps of:
reading data from a recording medium located externally to the portable terminal without contact therewith;
decoding the read data;
creating code files in a structured language from the decoded data; and
storing said code files;
reading a specified one of said stored code files in response to a user event;
executing said specified code file; and
driving said external-communication processing section to communicate with an external device in accordance with a communication protocol specified by said executed code file.

17. The method according to claim 16, wherein said read data is two-dimensional code data.

18. The method according to claim 16, wherein said read data includes data declaring code, graphical user interface code, code for determining whether a user event has occurred, and communication protocol specifying code.

19. The method according to claim 16, wherein said creating step further comprises creating the code file in a structured language selected from the group consisting of HTML, XHTML, XML, SGML, and Java.

20. An information processing system that processes information on demand, said system comprising:
a recording medium containing coded data, the coded data including a data declaration, a determining function, and specification of a communication protocol; and
a terminal which reads the coded data from said recording medium, decodes the coded data into a code file in a structured language including a data declaring function, a determining function and a communication protocol specifying function, stores a plurality of the code files, reads one of the stored code file, the read code file being selected by a user event, and communicates with an external device by using a specified communication protocol identified in the read code file.

21. A portable terminal operably connected to a network and operable to read data from a recording media without contact therewith, said portable terminal comprising:
processing means for reading coded data from a non-contact readable recording medium, generating a code file in a structured language, and executing or deleting the code file in response to a user request; and
display means for displaying information from the code file following execution of the code file by said processing means.
